(19) United States
(12) Patent Application Publication
(10) Pub. No.: US 2026/0056690 A1
(43) Pub. Date: Feb. 26, 2026

(54) Peer-to peer industrial printing system, print server,m and processing management method for efficiently dividing a jplurality of jobs into configured groups

(71) Applicant: KYOCERA Document Solutions Inc., Osaka (JP)

(72) Inventor: Taku MaTSUO, Los Angeles, CA (US)

(73) Assignee: KYOCERA Document Solutions Inc., Osaka (JP)

(21) Appl. No.: 18/831,171

(22) Filed: Aug. 26, 2024

(51) Int. Cl. G06F 3/12

(52) U.S. Cl. CPC G06F 3/124; G06F 3/1204; G06F 3/126; G06F 3/1285

(57) ABSTRACT

Provided is an industrial printing system that efficiently performs distributed processing of production printing on a peer-to-peer basis by dividing the jobs into groups. A memory part stores group settings corresponding to the processing capabilities and settings of component apparatuses. The group dividing unit reads the data contents and/or print instruction attributes for each of the plurality of jobs, generates the distribution conditions, and divides the jobs into groups corresponding to the group settings stored in the storage unit according to the distribution conditions. The processing management unit sends the jobs in the groups divided by the group dividing unit to other print servers corresponding to the groups to request processing.

### BACKGROUND

The present disclosure relates to an industrial printing system, print server, and processing management method that performs distributed processing, particularly for industrial printing (production printing).

As a typical printing system, a technology is described that enables optimal distributed processing by printing purpose, which also takes into account image quality and process finishing, without reducing the overall system throughput. In this technology, the server acquires a list of all printers connected to the network in advance, and based on this acquired information, detects printers that can print under the specified printing conditions. The detected printers are then stored as a distributed printing group. When a distributed printing instruction is received from a client terminal or a scanner apparatus, the distributed printing is executed to the printers in the distributed printing group that has been stored, previously.

On the other hand, in industrial printing, known as production printing, which uses commercial (industrial) printing apparatus, the components of the final product are produced by dividing the work among a plurality of processes. For example, in the case of bookbinding, the cover, body (color), body (black and white), promotional materials, belt, and shipping envelope are processed as different jobs. Then, each job is combined in the intermediate process to produce the final product, the book.

In these production printing systems (hereinafter referred to just as “typical technology”), a plurality of jobs that perform the same processing are managed in a batch on a management server, and a large number of print jobs may be processed in an evenly distributed printing process.

### SUMMARY

An industrial printing system of the present disclosure is an industrial printing system for production printing, having a plurality of print servers that performs distributed processing of a plurality of jobs, each of the plurality of print servers including: a storage unit that stores a group setting corresponding to a processing capability and a setting of a component apparatus; a group dividing unit that reads data content and/or print instruction attributes for each of the plurality of jobs, generates a distribution condition, and divides the plurality of jobs into a group corresponding to the group setting stored in the storage unit according to the distribution condition; and a processing management unit that transmits the jobs of the group divided by the group dividing unit to other print server associated with the group to request to be processed.

A print server of the present disclosure is a print server that performs distributed processing of a plurality of jobs in an industrial printing system for production printing, including: a storage unit that stores a group setting corresponding to a processing capability and a setting of a component apparatus; a group dividing unit that reads data content and/or print instruction attributes for each of the plurality of jobs, generates a distribution condition, and divides the plurality of jobs into a group corresponding to the group setting stored in the storage unit according to the distribution condition; and a processing management unit that transmits the jobs of the group divided by the group dividing unit to other print server associated with the group to request to be processed.

A processing management method of the present disclosure is a processing management method executed by an industrial printing system for production printing having a plurality of print servers that performs distributed processing of a plurality of jobs, including the steps of: storing a group setting corresponding to a processing capability and a setting of a component apparatus; generating a distribution condition by reading data content and/or print instruction attributes for each of the plurality of jobs; dividing the plurality of jobs into a group corresponding to the stored group setting according to the distribution condition; and transmitting the divided jobs of the group to other print server associated with the group to request to be processed.

### BRIEF DESCRIPTION OF THE DRAWINGS

FIG. 1 is an example of a system configuration diagram of an industrial printing system according to an embodiment of the present disclosure;

FIG. 2 is a block diagram showing the control configuration of the print server as shown in FIG. 1;

FIG. 3 is a block diagram showing the functional configuration of the print server as shown in FIG. 1;

FIG. 4 is a block diagram showing details of the job as shown in FIG. 3;

FIG. 5 is a flow diagram of the group dividing process according to the present disclosure; and

FIG. 6 is a conceptual diagram of the group dividing process as shown in FIG. 8.

### DETAILED DESCRIPTION

### Embodiments

### [Configuration of Industrial Printing System X]

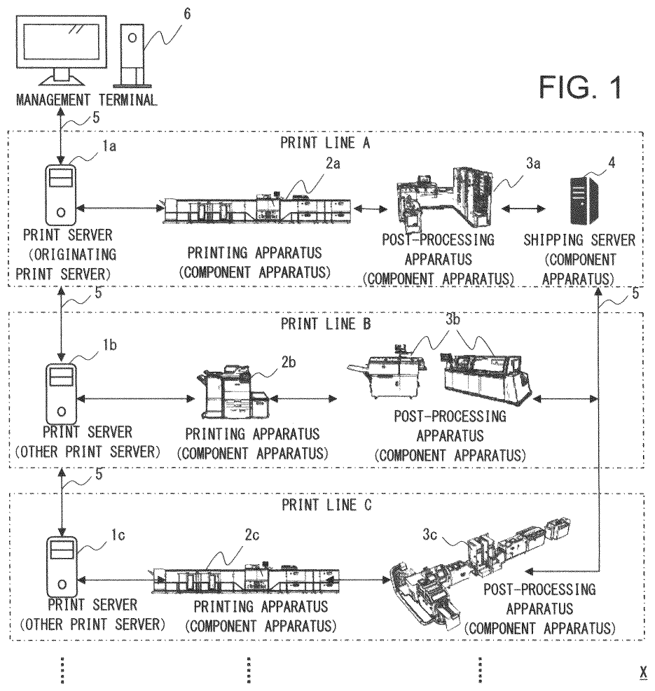

Firstly, with reference to FIG. 1, an example of the overall system configuration of the industrial printing system X of the present embodiment is described.

The industrial printing system X of the present embodiment is a system that executes the printing process and post-processing process (hereinafter simply referred to as “printing”) in industrial printing (production printing). The industrial printing system X is a system that executes output by

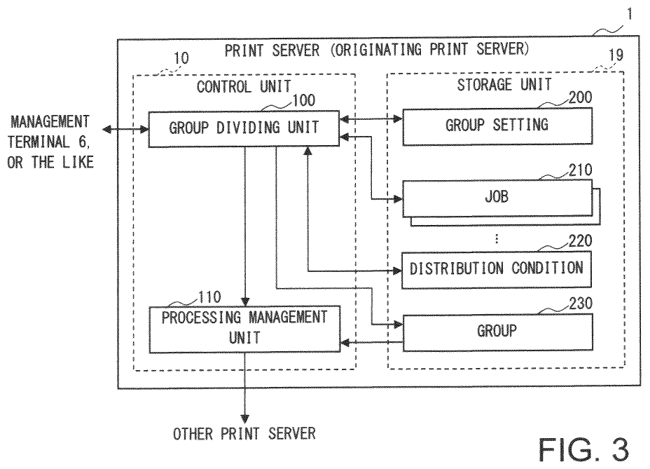

In the present embodiment of industrial printing system X, the final product such as a book to be output is referred to as an “order,” and each component of an order is referred to as a job 210 (FIG. 3).

In the industrial printing system X, the print servers 1 in sites (printing lines), which are printing companies, printing plants, or the like, are connected and linked by a network 5. The print server 1 on each printing line controls printing-related apparatuses, which include printing apparatuses 2, post-processing apparatuses 3, and dispatch servers 4, or the like, control the printing apparatus (hereinafter referred to as “component apparatuses”). The network 5 is also connected to a management terminal used by users such as the administrator of the industrial printing system X.

In FIG. 1, as an example of this coordination between sites, each of the print servers 1a, 1b, 1c, . . . in the print lines A, B, C, . . . , and the dispatch server 4 in the print line A are connected via network 5. Furthermore, in this example, the printing apparatuses 2a, 2b, 2c, . . . , and the post-processing apparatuses 3a, 3b, 3c, . . . , are connected with print servers 1a, 1b, 1c, . . . .

Hereafter, when indicating any one of these print servers 1a, 1b, 1c, . . . , it is referred to simply as “the print server 1.” Similarly, when any one of these printing apparatus 2a, 2b, 2c, is referred to simply as “the printing apparatus 2.” Similarly, when any one of post-processing apparatuses 3a, 3b, 3c, is simply referred to as “the post-processing apparatus 3.”

The Print server 1 is an information processing apparatus that serves as a print controller or DFE (Digital Front End) that manages and controls the component apparatuses provided at each location. The print server 1 is configured such as a PC (Personal Computer), a server, a dedicated machine, a general-purpose machine, or the like. In the present embodiment, the print server 1 assigns the processing of the job 210 to each component apparatus in the relevant location and causes them to execute the processing according to a schedule.

Hereinafter, the print server 1 at each of the site is peer-to-peer connected to the others and is to be a distributed destination.

In the present embodiment, the print server 1 sends and receives various instructions and information with the printing apparatus 2, post-processing apparatus 3, and dispatch server 4, or the like, in production printing. In this way, print server 1 manages the status of each apparatus and requests the processing of job 210.

In addition, in the present embodiment, the print server 1 executes dedicated print management (order output management) application software (hereinafter simply referred to as “application”). Thus, the print server 1 performs the peer-to-peer distributed processing of the jobs 210 (FIG. 3) in production printing. The print management application (hereinafter referred to as the “dedicated application”) may be executed on a common platform. On this common platform, print design creation, user management, tenant management, security management, maintenance notification services, prepress process management, storage management for each document, management of the printing apparatuses 2, or the like, may be performed.

In the present embodiment, the print server 1 that is the requesting side of the process is hereinafter referred to as the “originating print server.” In the following example, print server 1a is the originating print server.

On the other hand, in the present embodiment, the print server that is the side being requested processing is hereinafter referred to as the “other print server.” In the following example, print servers 1b and 1c are the other print servers.

The printing apparatus 2 is an industrial printer including an imaging apparatus, an automated offset printing apparatus, a digital printer, an MFP (Multi-Functional Peripheral), or the like. The printing apparatus 2 is capable of executing printing processes such as small-lot printing or large volume (multi-lot) offset printing.

The printing apparatus 2 at each location may have different size, paper quality, color profile, recordable range, or the like, of the recording paper used in the printing process.

The post-processing apparatus 3 is capable of performing processing after printing (post-processing) such as folding, collating, binding, cutting, binding, or the like, of the recording paper printed by the printing apparatus 2.

The post-processing apparatus 3 at each location for the present embodiment may also differ in terms of the content, range, or the like, of the processing that can be performed in the post-processing process.

The dispatch server 4 is a server that manages the dispatch of orders sent from each site after printing or post-processing has been completed.

In the present embodiment, an example by using the dispatch server 4 at the site A is described. However, other sites may also be provided with a dispatch server 4.

The network 5 is a LAN (Local Area Network), wireless LAN (Wi-Fi), WAN (Wide Area Network), cellular phone network, industrial network, voice telephone network, other dedicated line, or the like. The network 5 can send and receive various commands and data to and from each apparatus. Furthermore, the print server 1 and each component apparatus may also be connected to each other by an intra-site network, such as LAN, or the like, in the network 5. In addition, the network 5 may be configured as a VPN (Virtual Private Network), or the like.

The management terminal 6 is an information processing apparatus such as a PC, smartphone, tablet terminal, PDA (Personal Data Assistant), or the like. The management terminal 6 is used by a user such as an administrator, or the like, to control printing. In the present embodiment, the management terminal 6 executes the dedicated application to set a group settings 200 (FIG. 3), set a distribution conditions 220, and check estimates of costs, or the like.

Additionally, the management terminal 6 can also run an application to control the design and prepress in production printing. In addition, the management terminal 6 may be connected to another terminal for submission, design proofing, or the like, for the design and prepress. In addition, the management terminal 6 may also be equipped with the functions of a management apparatus that generates the jobs 210 and manages the processing requests for each apparatus by the print server 1. This makes it possible to acquire the jobs 210, design of printing, perform submission, manage prepress processing, and perform checking progress status and processing requests, and the like.

There may be a plurality of these apparatuses depending on the usage, scale of printing, or the like. Each apparatus can be connected to the print server 1 by various protocols via the network 5 and LAN, or the like. Alternatively, the print server 1 and each apparatus may be directly connected by wired lines by using various interfaces.

In addition, each location may be provided with the other component apparatuses that are managed by the print server 1. These other component apparatuses include, for example, a terminal for submission, a terminal for design proofing, prepress apparatus, or the like.

In addition, the other general terminal used by a user may be connected via the network 5 inside or outside each site. This general terminal may include a so-called console.

In this way, each print server 1 can be accessed by the user by the management terminal 6 or the general terminal by using a web browser, a terminal application, or the dedicated application. This makes it possible to perform to acquire the jobs 210, divide them, design them for printing, submit them, manage prepress processing, check the progress, request processing, and the like.

### [Control Configuration of Print Server 1]

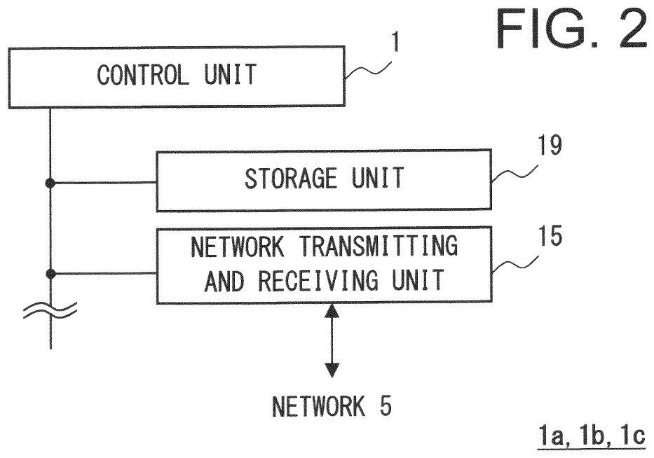

Next, with reference to FIG. 2, the control configuration of the print server 1 is described.

The print server 1 includes a control unit 10, a network transmitting and receiving unit 15, and a storage unit 19. Each unit is connected to the control unit 10 and its operation is controlled by the control unit 10.

The control unit 10 is an information processing unit such as a general purpose processor (GPP), a central processing unit (CPU), a micro processing u (MPU), a digital signal processor (DSP), a graphics processing unit (GPU), a neural processing unit (NPU), an application specific integrated circuit (ASIC) or an application specific processor, or the like.

The control unit 10 is made to operate as each of the functional blocks as described later by reading a control program stored in the ROM or HDD in the storage unit 19, expanding this control program into the RAM, and executing it. The control unit 10 also controls the entire apparatus according to the instruction information input from the management terminal 6 or the general terminal.

The network transmitting and receiving unit 15 is a network connection unit that includes a LAN board and a wireless transmitting and receiving unit for connecting to the network 5.

The network transmitting and receiving unit 15 transmits and receives data on data communication lines and voice signals on voice telephone lines.

The storage unit 19 is a computer-readable non-transitory recording medium. The storage unit 19 includes semiconductor memory such as read only memory (ROM) and a random access memory (RAM) and magnetic storage such as a hard disk drive (HDD), or the like.

The ROM and HDD of storage unit 19 store a control program for controlling the operation of print server 1. This control program includes the operating system (OS), middleware on the OS, services (daemons), various applications, and database data. The various applications include the printing process management application described above.

In the present embodiment, the storage 19 is a raster-in-process (hereinafter abbreviated as “rasterize” or “RIP”) that converts vector (line drawing) image data into dotted image data for printing (raster data). The program and data for the process of rasterizing may be stored. This program and data for the rasterizing process also includes commercial libraries, fonts, or the like.

In addition, the storage unit 19 also stores information on component apparatuses connected to the same printing line, programs for control, or the like. Further, the storage unit 19 may also store account settings, other data, or the like, for users of the industrial printing system X.

In the print server 1, the control unit 10 may be integrally formed as a CPU with a built-in GPU, a chip-on-module package, a system on a chip (SOC), or the like.

The control unit 10 may also have a built-in RAM, ROM, flash memory, or the like.

### [Functional Configuration of Print Server 1]

Here, with referring now to FIG. 3, the functional configuration of print server 1 is described.

The control unit 10 of the print server 1 has a group dividing unit 100 and a processing management unit 110.

The storage unit 19 stores a group setting 200, a distribution condition 220, a job 210, and a group 230.

The group dividing unit 100 reads the data content and/or print instruction attribute for each of the plurality of jobs 210 and generates the distribution conditions 220. Specifically, the group dividing unit 100 may set the distribution condition 220 based on information related to color mode, post-processing, or spot colors.

Then, the group dividing unit 100 divides the plurality of jobs 210 into the groups 230 corresponding to the group setting 200 stored in the storage unit 19 by using the generated distribution condition 220. At this time, the group dividing unit 100 can set, in the distribution conditions 220, any of the plurality of print servers 1, printing apparatuses 2, and post-processing apparatuses 3 that can process the job 210, based on the type of job 210.

In addition, the group dividing unit 100 can also set the group 230 itself according to the processing capabilities or settings of the component apparatuses in the distribution destination.

Also, the group dividing unit 100 can calculate the processing time when a plurality of jobs 210 are processed according to the distribution condition 220 as estimation data.

In this case, the group dividing unit 100 calculates the processing time when the plurality of jobs 210 is equally divided and processed, and it identifies the distribution condition 220 and the group 230 that can be processed faster than the processing time processed by equal division.

In addition, the group dividing unit 100 can select and divide a group 230 (lower group) that matches the distribution condition 220 within the group 230 (higher group), which has already been divided.

The processing management unit 110 transmit the jobs 210 in the group 230 divided by the group dividing unit 100 to the other print server specified by the distribution conditions 220 to request processing. In this case, the processing management unit 110 causes one of the other print servers, the printing apparatuses 2, or the post-processing apparatuses 3 designated for each group 230 to process the job. More specifically, the processing management unit 110 transmit the job 210 to the other print server at the location where the designated apparatus is located.

Furthermore, the processing management unit 110 may manage the processing of the job 210 by transmitting and receiving the job 210 itself, the data processed by the job 210, and processing status and completion notifications between the print servers 1.

The group setting 200 is configuration information for the group 230 corresponding to the processing capabilities and processable settings supported in the print server 1 and component apparatuses at each site.

Specifically, the group setting 200 may be a setting that groups the component apparatuses at the distributed locations according to their processing capabilities and settings. For example, the group setting 200 may group for monochrome printing with respect to color processing. In this case, the printing apparatuses 2 for color printing and the printing apparatuses 2 are grouped. Alternatively, the group setting 200 may group with respect to having special color printing processing capability. In this case, the printing apparatuses 2 that only prints normal cyan, magenta, yellow, and key plate (CMYK) colors and the printing apparatuses 2 that has capability to print a special color that specify colors other than CMYK (hereinafter referred to as “+ alpha colors”) may be grouped. Specifically, these “+ alpha colors” include colors other than CMYK such as white, transparent, gold, silver, pink, hologram printing, and the like.

Further, the group setting 200 may be a setting to group with respect to the color profile. In such case, the printing apparatuses 2 that provides with a specific ICC profile and printing apparatuses 2 that does not provide it may be grouped.

The group setting 200 may also be a setting for grouping based on processable printing paper (supported paper), ink, resolution, or the like. In such case, the printing apparatuses 2 that support specific paper, ink, resolution, or the like, and the printing apparatuses 2 that do not support them may be grouped.

The group setting 200 may also be a setting for grouping with respect to post-processing. In such case, the post-processing apparatuses 3 that are capable of a particular finishing process and the post-processing apparatuses 3 that are not capable of the process may be grouped.

Furthermore, the group setting 200 may be a setting to be grouped according to the presence or absence of a commercial library pertaining to color designation. These commercial libraries include PANTONE® HKS, DIC®, TOYO®, or the like. In the present embodiment, the settings of the color profile and the spot color information are collectively referred to as the “color mode.”

The group setting 200 may be a setting to be grouped according to the availability of fonts that can be used.

The group setting 200 may also be a setting to be grouped by, for example, the processing capability when performing RIP at the print server 1, the presence or absence of image enhancement, skew correction, and other processing, the presence or absence of plug-ins, or the like. The plug-ins may be those that perform processing of imposition, preflight, preflight profile, and the like.

The group setting 200s may also be a setting to be grouped by output speed (hereinafter referred with “throughput”) with respect to paper printing and post-processing. This output speed may be set, for example, by a value such as the number of processing pages per minute (PPM).

In addition to this, the group settings 200 may also include alternative settings for capabilities and setting states that can be substituted. These alternative settings may be set for color modes, fonts, or the like, for example, whether or not they are substitutable. Furthermore, if the substitution is possible, the alternative settings may include settings such as the extent to which substitutions are allowed.

Here, the group setting 200 may be set up as a group 230 between component apparatuses of the print server 1 at different sites. In such case, a representative print server 1 for each group 230 is configured. This allows the job 210, which once sent to the representative print server 1 for the group 230, to be transferred from the representative print server 1 to the print server 1 at the different site.

In the present embodiment, the group setting 200 is set by the user, as described later.

The distribution condition 220 is setting information pertaining to the conditions for distributing a plurality of jobs 210 to each group 230. Here, in the present embodiment, the distribution of the plurality of jobs 210 by grouping them into the groups 230, division into groups 230, or the like, may simply be referred to as “grouping.”

In the present embodiment, the distribution condition 220 may also include estimation data.

The estimation data may be data of estimations for processing the jobs 210 in each group 230 when the plurality of jobs 210 are divided into groups 230. For example, the estimation data may include estimates of printing and post-processing time, estimates of the amount of consumables such as ink and paper, and other cost estimates.

The job 210 is data that collects various data used during printing in production printing. The job 210 may be described, for example, in JDF (Job Description Format) and/or JMF (Job Messaging Format).

The details of the job 210 are described later.

The group 230 is a set of jobs 210 grouped together by the distribution condition 220 as described above.

In the present embodiment, the jobs 210 corresponding to the group 230 are transferred to the other print server and requested to be processed.

### (The Details of Job 210)

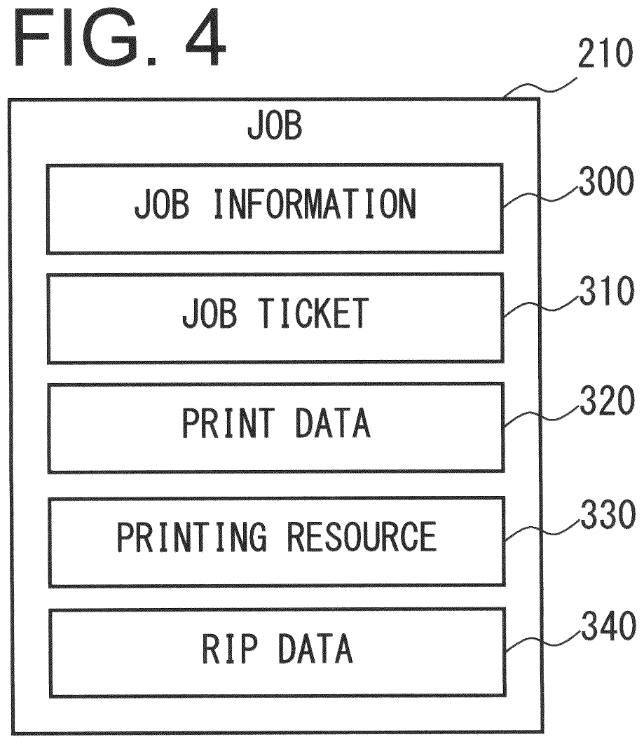

Then, with reference to FIG. 4, the details of job 210 are explained.

In the present embodiment, the data mainly used in rasterization, printing, and post-processing in job 210 is explained.

The job 210 includes job information 300, a job ticket 310, print data 320, and print resources 330, or the like (hereafter, these are also referred to as “data contents”). Depending on the type of the job 210, the job 210 may also include RIP data 340 as data contents.

The job information 300 is data that includes attributes specified in the printing process (hereinafter referred to as “specified attributes”). The job information 300 sets the type of job 210, the name of job 210, the name of the project (order), the designation of printing apparatus 2 or post-processing apparatus 3, the number of copies and whether collating is performed, whether recording is performed, the number of mm for cutting, the printing direction, the printing status, the priority order, or the like, as the designated attributes. The types of the job 210 include a job for processing rasterization (a rasterization job), a job for printing process (a printing job), and a job for post-processing process (a post-processing job).

The job ticket 310 is configuration data that includes print instruction attributes for requesting the job 210. The job ticket 310 includes, as print instruction attributes, lower-level settings in the workflow that are settings for the order. The lower-level settings includes, for example, color mode designation, imposition designation, paper designation, binding designation, and the like, which are the necessary settings for the printing process and post-processing process. In the present embodiment, the job ticket 310 may include reservation information to designate a printing apparatus 2 or a post-processing apparatus 3. This reservation information may correspond to the group 230 as described above.

The job ticket 310 may also be described in JDF and/or JMF.

The print data 320 is data of a print document whose design is set according to the order. The print data 320 may be, for example, electronic document data such as portable document format (PDF), post script (PS) data, other vector data, data in a format for submission, or other raster image data.

The printing resources 330 are information on various resources necessary for printing instructions, such as color modes, fonts, or the like. These various resources correspond to the group setting 200.

The other resource data necessary for printing may also be included in the print resource 330.

The RIP data 340 is data of PDF, or the like, having image data that has been rasterized based on the job ticket 310. This image data may be, for example, TIFF or other bitmap data. Additionally, the image data may be lossless or lossy compressed.

Additionally, the job 210 may have recording information for process changing.

In addition to this, the storage unit 19 may store schedule information indicating the status of the schedule for the execution of each job 210. This schedule information may include the status of the job 210, shipping records, and the operating status of each component apparatus. Among these, the shipping record is information about the physical dispatch of printed materials after printing, and may include, for example, information such as printing completion time, shipping time, receipt time, or the like.

Here, the control unit 10 of the print server 1 is made to function as the group dividing unit 100 and the processing management unit 110 by executing the control program stored in the storage unit 19.

The components of the print server 1 as described above are hardware resources that execute the processing management method according to the present disclosure.

Some or any combination of the functional configurations described above may be configured hardware or circuitry by components of ICs, programmable logic, FPGA (Field-Programmable Gate Array), or the like.

### [Group Division Process by Print Server 1]

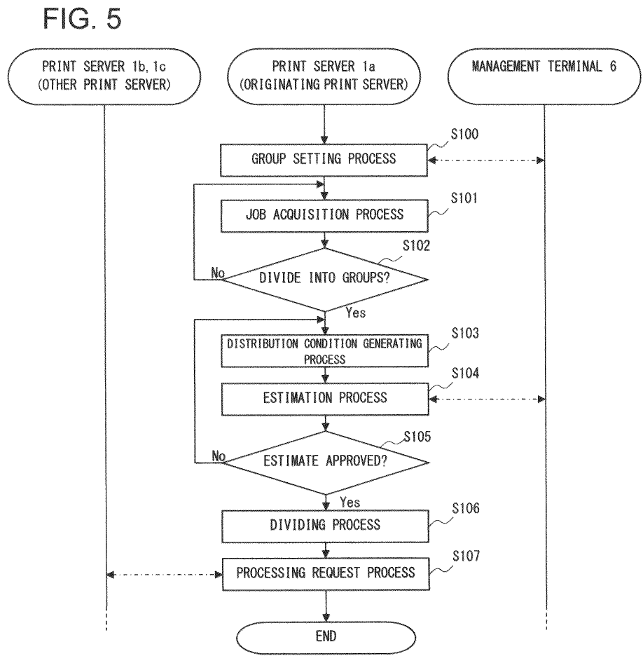

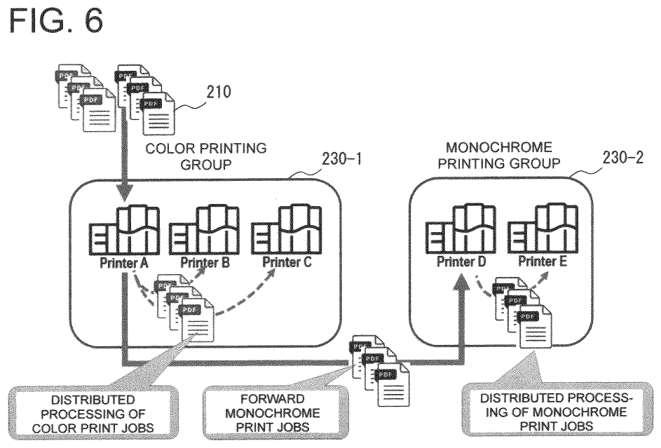

Next, with reference to FIGS. 5 to 6, a group division process by print server 1 according to the present embodiment in the present disclosure is explained.

In the present embodiment of group division process, each print server 1 stores the group setting 200 corresponding to the processing capabilities and settings of the component apparatuses. On this basis, for each of the plurality of jobs 210, the data contents and/or print instruction attributes are read. Thus, the plurality of jobs is divided into groups 230 corresponding to the stored group settings 200. The jobs 210 in the divided group 230 are then transferred to the other print servers corresponding to the group 230 for requesting of processing.

In the group division process according to the present embodiment, as a representative example, the print server 1a of print line A (site) is used as the originating print server (processing request side). The following describes an example that the control unit 10 of this print server 1a primarily executes the program stored in the storage unit 19, cooperating with each unit, and using hardware resources.

In the following, with reference to the flowchart in FIG. 5, the details of the group division process are explained step by step.

### (Step S100)

Firstly, the group dividing unit 100 performs the group setting process.

The group dividing unit 100 sets the group 230 according to the processing capabilities or settings of the component apparatuses of each print server 1.

Specifically, the group dividing unit 100 refers to the installation location, print line flow, processing capacity, and settings of each component apparatus. Then, the group dividing unit 100 can calculate which component apparatuses are suitable for processing as a group as setting candidates for the group 230. This calculation may be performed, for example, by using a genetic algorithm (GA).

The group dividing unit 100 sets the group setting 200 by presenting the calculated setting candidate of the group 230 to the user via the graphical user interface (GUI) in the dedicated application at the management terminal 6, for example, and allowing the user to select one.

### (Step S101)

Then, the processing management unit 110 performs the job acquisition process.

The processing management unit 110 may acquire a plurality of jobs 210 from a plurality of print servers 1, inter-site management systems that are upstream of the industrial printing system X, management terminals 6, prepress apparatus, or the like, by using the management terminal 6 and sequentially stores them in the storage unit 19. Each of the plurality of jobs 210 may be generated by the management terminal 6 by using a manuscript submitted from the submission terminal.

### (Step S102)

Then, the processing management unit 110 determines whether to divide the plurality of jobs 210 into the groups 230 or not. The processing management unit 110 determines the number of jobs, number of output sheets, output time, or the like, for the plurality of jobs 210 stored in the storage unit 19 and determines Yes if the acquired jobs 210 need to be divided into the groups 230. The processing management unit 110 can determine Yes, for example, when a large number of jobs 210 more than a specific number of jobs are accumulated. The processing management unit 110 otherwise determines No.

In Yes, the group dividing unit 100 proceeds to step S102.

In No, the group dividing unit 100 returns the process to step S101 and continues to acquire the job 210.

### (Step S103)

If dividing a job into groups 230, the group dividing unit 100 performs the distribution condition generating process.

The group dividing unit 100 can generate the optimal distribution conditions 220 from the plurality of jobs 210 stored in the storage unit 19.

In the present embodiment, the group dividing unit 100 is capable of analyzing the data contents from each of the jobs 210 and generating the distribution condition 220.

For example, the group dividing unit 100 can generate the distribution condition 220 by referring to the job tickets 310 of the jobs 210. The group dividing unit 100 can generate the distribution condition 220 based on the color processing specification, paper specification, and finishing process specification as print instruction attributes in the job ticket 310.

Alternatively, the group dividing unit 100 can perform a preflight check if the job 210 is a PDF, or the like, extract the specified color profile and other attributes, and generate the distribution conditions 220 based on these.

Alternatively, the group dividing unit 100 can analyze the plurality of jobs 210 to generate the distribution condition 220.

Specifically, the group dividing unit 100 analyzes the job ticket 310 and content information for each of the job 210. From the results of this analysis, the group dividing unit 100 can extract conditions that can divide the plurality of jobs 210 for printing into the plurality of groups 230, which can then be generated as the distribution conditions 220. For example, if the plurality of jobs 210 can be divided into color and monochrome print jobs, the group dividing unit 100 can generate the distribution condition 220 for this color designation. Conversely, if all of the plurality of jobs 210 are color print jobs or all are monochrome print jobs, the group dividing unit 100 does not generate the distribution condition 220 for the color designation.

Alternatively, if the plurality of jobs 210 can be divided into CMYK color jobs and CMYK+ alpha color jobs, the group dividing unit 100 can generate this as the distribution condition 220. In this case, conversely, if all of the plurality of job 210 are CMYK color or all of them are CMYK+ alpha color, the group dividing unit 100 does not generate this as the distribution condition 220.

In addition, the group dividing unit 100 can generate the distribution condition 220 based on the paper, ink, resolution, ICC profile, commercial library for color designation, presence or absence of fonts, processing capability of RIP, image enhancement, presence or absence of skew correction or other processing, presence or absence of plug-ins, or the like, specified in the plurality of jobs 210. In other words, the group dividing unit 100 can generate the distribution condition 220 based on these differences.

The group dividing unit 100 may also generate the distribution condition 220 based on whether or not a specific post-processing is designated.

Furthermore, the group dividing unit 100 can also generate the distribution condition 220 by combining the rules that has already been set in the distribution condition 220. Specifically, as in the example described later, the group dividing unit 100 can set the distribution conditions 220 such as dividing into groups 230 by paper type and further dividing into groups 230 by whether color or monochrome printing is designated. In other words, it is also possible to perform a hierarchical division into groups 230.

On this basis, the group dividing unit 100 selects and associates the optimal group 230 for each of the generated distribution conditions 220, respectively, by referring to the group setting 200.

Specifically, the group dividing unit 100 refers to the rasterization processing capacity, print processing capacity, and post-processing capacity of each component apparatus in each group 230 in the group setting 200, and selects and associates the group 230 that best matches the distribution condition 220. Alternatively, the group dividing unit 100 may select and associate the group 230 that best matches the distribution condition 220 for the “Ready” state setting status that can be processed by each component apparatus.

For example, if the distribution condition 220 is set to divide by color printing and monochrome printing (dividing by color mode), the group dividing unit 100 associates a group including a large number of printing apparatuses 2 capable of color printing and a group including a large number of printing apparatuses 2 capable of only monochrome printing with respective groups 230.

Alternatively, the group dividing unit 100 may also associate CMYK colors, CMYK+alpha colors, paper, ink, resolution, ICC profile, commercial library for color specification, availability of fonts, processing capability of RIP, image enhancement, skew correction, and availability of specific post-processing designation to the groups 230.

Furthermore, the group dividing unit 100 can further select and divide groups 230 that meet the distribution condition 220 within the group 230 to be divided.

Specifically, the group dividing unit 100 can correspond each group 230 according to the distribution conditions 220, such as dividing into the groups 230 by color mode and further dividing into the groups 230 by paper type. At this time, the group dividing unit 100 may set the groups 230 that become the new lower groups divided within one group 230 (hereinafter referred to as the “upper group”) in the group setting 200 by associating each of them with the upper group in a tree structure, or the like.

### (Step S104)

Then, the group dividing unit 100 performs the estimation process.

The group dividing unit 100 estimates the processing cost when the plurality of jobs 210 are processed according to the distribution condition 220.

Specifically, the group dividing unit 100 divides the plurality of jobs 210 according to the generated distribution conditions 220 and calculates the processing time when the plurality of print jobs 210 are processed in each of the divided groups 230. The group dividing unit 100 may calculate the processing time of a job 210 from the number of printed pages of the job 210 and the average throughput (Pages Per Minutes) of each component apparatus in the group 230, or the like.

Alternatively, if the representative print server 1 for the group 230 is capable of estimating the processing time of the job 210, it may send the information of each job 210 in the group 230 to this print server 1 and request it to calculate the processing cost.

Specifically, the group dividing unit 100 analyzes each job 210 based on the distribution conditions 220 to determine the processing requirements. In this case, the group dividing unit 100 determines from the job information 300, job ticket 310, print data 320, and print resource 330 included in the job 210, that is, based on the data content, whether it matches the distribution condition 220. The group dividing unit 100 then sets up the jobs 210 that meet the distribution conditions 220 to be distributed to the respective groups 230.

Here, firstly, the group dividing unit 100 calculates the processing time when the plurality of job 210 are divided equally and processed.

With referring to FIG. 6, an example that the distribution condition 220 is a division by color printing and monochrome printing. In this example, the group 230-1 is associated with color printing (hereinafter referred to as “color printing group”), and the group 230-2 is associated with monochrome printing (hereinafter referred to as the “monochrome printing group”). Also, in this example, the color printing group has three printing apparatuses 2 that can print in color, and the monochrome printing group has two printing apparatuses 2. Therefore, when the plurality of job 210 are equally processed, the group dividing unit 100 divides the job 210 for color printing into three equal parts by the three printing apparatuses 2 in the color printing group, and it divides the job 210 for monochrome printing into two equal parts by the two printing apparatuses 2 in the monochrome printing group. The group dividing unit 100 then calculates the processing time in the case of equal division.

On this basis, the group dividing unit 100 identifies the distribution condition 220 and the groups 230 that can be processed faster than the processing time with equal division.

The group dividing unit 100 first optimizes the number of jobs 210 processed according to the capability and setting information of the component apparatuses according to the distribution conditions 220 within the currently selected group 230. Specifically, in the above example, the group dividing unit 100 allocates the processing of more jobs 210 to the printing apparatus 2 that has a higher color printing throughput than the other apparatus in the color printing group. Similarly, in the monochrome printing group, the printing apparatus 2 with a higher monochrome printing throughput than the other apparatus is assigned to process more jobs 210. The group dividing unit 100 calculates the processing time under these conditions.

In the above example, it is also possible that there may be printing apparatuses with remarkably high monochrome printing throughput even associated in a color printing group.

For this reason, the processing time is calculated in a different kind of grouping, distributed by the other distribution conditions 220, and in a state where the jobs 210 is processed in an equal division or in an optimized number of processing. If there are a plurality of distribution conditions 220, the group dividing unit 100 can calculate and rank the processing times for all of them.

In this way, the group dividing unit 100 identifies the distribution conditions 220 and groups 230 that can be processed faster than the processing time processed by equal division.

Furthermore, the group dividing unit 100 can further select and divide groups 230 that meet the distribution conditions 220 within the group 230 to be divided.

For example, in an example where three printers 2 for color printing and two printers 2 for monochrome printing are included in a single group 230 (upper group) in the group 230 set by the distribution condition 220 according to paper type, the group dividing unit 100 can set subgroups by paper type for the color print job 210 that has been assigned to the color printing apparatuses 2. In this case as well, it is possible to calculate the processing time.

Here, the group dividing unit 100 may assign the job 210 to a group that includes its component apparatuses if the job 210 has reservation information set to it.

Furthermore, the group dividing unit 100 can also calculate costs other than the processing time, such as the amounts of consumables, or the like, in an equivalent manner. The group dividing unit 100 can also generate a list in which the amounts of consumables, or the like, are ranked.

In this list, the group dividing unit 100 may sort it so that the best group 230 is at the top of the list based on the particular processing cost criterion. This particular processing cost criterion may be set to criteria such as cost-oriented, processing time-oriented, or less consumable usage-oriented. Alternatively, the group dividing unit 100 may select the best group 230 by statistical method, such as genetic algorithms, or AI (Artificial Intelligence) processing when sorting.

The group segmentation unit 100 may send the list to the dedicated application of the management terminal 6.

The GUI of the dedicated application in the management terminal 6 can display this list, including the cost of process, processing time, amount of consumables, other costs, and the like, in each group 230.

On the GUI, the user can check the optimal rule when dividing by each rule and select and instruct the optimum rule.

The user can also use the GUI to indicate the specific processing cost criteria, the distribution condition 220, or the like, as described above. At this time, the user may set these by using a template, or the like.

This allows the user to select the optimal distribution conditions 220 and groups 230.

The group dividing unit 100 can acquire these user instructions for estimation from the management terminal 6.

### (Step S105)

Then, the group dividing unit 100 determines whether the estimate has been approved or not. The group dividing unit 100 determines Yes if the user has given an indication of approval of the estimate in the GUI of the dedicated application, or the like. The group dividing unit 100 also determines No in other cases.

In Yes, the group dividing unit 100 proceeds the process to step S106.

In No, the group dividing unit 100 returns the process to step S103 and continues to generate and estimate the distribution condition 220.

### (Step S106)

If the estimate is approved, the group dividing unit 100 performs the dividing process.

The group dividing unit 100 divides the plurality of jobs 210 into the groups 230 based on the distribution condition 220 at the time of the estimate as described above.

### (Step S107)

Then, the processing management unit 110 performs the processing request process.

The processing management unit 110 transmits the jobs 210 in the group 230 divided by the group dividing unit 100 to the other print server associated with the group 230 to request processing. At this time, the other print server causes the jobs 210 to be processed at each component apparatus under the above-mentioned distribution conditions 220.

Here, if the component apparatuses for the print servers 1 at different sites are set up as the group 230, the other print server may be the representative print server 1 for the group 230 as described above. In this case, the processing management unit 110 of the representative print server 1 for the group 230 first sorts of the transmitted jobs 210. After this, the processing management unit 110 can also transfer a job 210 for a component apparatus connected to a different print server 1 to the different print server 1.

Further, the processing management unit 110 may cause the jobs 210 processed to each component apparatus with the equal division as described above or with the optimized processing number.

Additionally, the processing management unit 110 may distribute the job 210 to a component apparatus of a lower group within the divided group 230. In other words, the processing management unit 110 can further distribute the job 210 of the higher group to a group 230 (lower group) that satisfies the distribution condition 220.

Through these processes, rasterization processing, printing processing, and post-processing of the jobs 210 are executed at the component apparatuses set in the group 230.

Furthermore, before and after this processing request and completion, the processing management unit 110 may send and receive processing status notifications and completion notifications for the job 210 between the print servers 1. In other words, the processing management unit 110 can manage the processing status and the completion of processing.

As described above, the group division process according to the present disclosure is completed.

As configured in this way, the following effects can be obtained.

In a typical production printing system, print processing has been distributed among a plurality of printers for the purpose of efficiently processing a large number of print jobs. In this process, a plurality of jobs that perform the same processing has been sometimes divided equally and distributed for processing.

However, if simply dividing a plurality of jobs equally and distributing them, for example, sometimes required more time and effort because some of the job has settings that cannot be printed on a printing apparatus at the distribution destination, or the paper in the paper feed tray had to be changed. This resulted in inefficiencies.

In contrast, the industrial printing system X of the present embodiment is an industrial printing system that performs production printing and has a plurality of print servers 1 that perform distributed processing of a plurality of jobs 210, each of the plurality of print servers includes: a storage unit 19 that stores a group setting 200 corresponding to a processing capability and a setting of a component apparatus; a group dividing unit 100 that reads data content and/or print instruction attributes for each of the plurality of jobs 210, generates a distribution condition 220, and divides the plurality of jobs 210 into a group 230 corresponding to the group setting 200 stored in the storage unit 19 according to the distribution condition 220; and a processing management unit 110 that transmits the jobs 210 of the group 230 divided by the group dividing unit 100 to other print server associated with the group 230 to request to be processed.

By configured in this way, a large number of jobs 210 can be divided with the optimal distribution condition 220 based on the content information and settings of the print data 320, or the like. This enables more efficient distributed processing than typical techniques when a large number of jobs 210 are printed at a plurality of sites, or the like.

On the other hand, distributed processing, in which printing is distributed and processed by a plurality of printing apparatuses, requires a management server that transmits and manages 320 print data to a plurality of printing apparatuses. Therefore, in production printing, there is a need for an industrial printing system that can achieve flexible and efficient division into groups by distributed processing in a peer-to-peer manner, without using a management server.

In contrast, the industrial printing system X according to the present embodiment can realize division into the groups 230 by flexible and efficient distributed processing in a peer-to-peer manner without using a management server. In other words, the division into the groups 230 allows a plurality of printing lines to work together to improve the efficiency of the entire printing process. Specifically, the division into groups 230 can be flexibly performed without being limited to one printing line. That means, the plurality of jobs 210 can be distributed and processed by using an optimal division method.

In the industrial printing system X, the group dividing unit 100 calculates the processing time when a plurality of jobs 210 is processed according to the distribution condition 220.

By configured in this way, the optimal distribution condition 220 can be selected based on the processing time to perform efficient distribution processing. Also, according to the nature of a large number of jobs 210, they can be divided into groups 230 and distributed for processing according to the optimal distribution conditions 220. Thus, more efficient processing of job 210 can be performed at a lower cost.

In the industrial printing system X, the group dividing unit 100 calculates the processing time when the plurality of jobs 210 is equally divided and processed, and it determines a distribution condition 220 and a group 230 that can be processed faster than the processing time with equal division.

By configured in this way, a plurality of jobs 210 to be processed more efficiently than if they are evenly divided among the component apparatuses in a group 230. In other words, more efficient distribution conditions 220 and groups 230 can be identified, allowing more efficient distributed processing. Thus, the processing of a large number of jobs 210 can be made more efficient overall.

In the industrial printing system X, the group dividing unit 100 further selects and divides a group 230 that matches the distribution conditions 220 within the group 230 to be divided.

By configured in this way, more optimal division of the jobs 210 even if the processing capabilities and settings of the component apparatuses within the group 230 are different. This enables efficient distributed processing.

In the industrial printing system X, the group dividing unit 100 sets the group 230 according to the processing capabilities or settings of the component apparatuses in the distribution destination.

By configured in this way, if dividing a large number of jobs 210, the print server 1 and its component apparatuses at the distribution destination can be divided into the groups 230 considering the processing capacity and setting status of the component apparatuses. Thus, it is possible to efficiently distribute and process a large number of jobs 210. In addition, set changes such as changing paper sets during printing can be minimized. Thus, printing operations can be made more efficient.

In the industrial printing system X of the present embodiment, the group dividing unit 100 sets a representative print server 1 for each group 230, even a component apparatus connected in a print server 1 at a different site is set as a group 230, and the processing management unit 110 transfers the job 210 to be processed by the component apparatus connected in the print server 1 in the different site from the representative print server 1 to the different print server 1.

With this configuration, the print servers 1 can be linked to each other in a peer-to-peer manner and managed as a group 230 even if the component apparatuses are located at different sites. This makes it possible to easily link sites such as existing companies, or the like, and improve efficiency by dividing the jobs 210 into groups 230.

### OTHER EMBODIMENTS

In the embodiments described above, an example has been described in which the group setting 200 is set first, and on this basis, the distribution condition 220 is set when estimating a plurality of jobs 210.

However, it is also possible to configure the plurality of distribution conditions 220 to be set first, and then the group settings 200 to be set on top of this. In addition, the group setting 200 itself may be dynamically changeable according to the settings of the plurality of jobs 210 and the capability and configuration information of each component apparatus.

Furthermore, the above embodiment describes an example of dividing the plurality of jobs 210 into the groups 230 at the time of estimation.

However, in the time of actually dividing, the plurality of jobs 210 may be dynamically divided into groups 230 according to the distribution conditions 220. In such case, the plurality of jobs 210 may be divided in a manner different from that at the time of estimation.

In the embodiment described above, the example of setting the distribution condition 220 is described when a large number of jobs 210 has already been stored.

However, it is also possible to set the distribution condition 220 separately from the acquisition of the job 210.

By configuring in this way, various configurations can be accommodated. Thus, for example, it is possible to flexibly set the distribution conditions 220 at the necessary point in time, make an estimate, or divide the jobs 210 and have them processed.

Although the above embodiment describes an example of dividing the plurality of jobs 210, it is also possible to divide the job 210 itself and then associate the divided jobs 210 with groups 230 according to the distribution conditions 220.

By configuring the system in this way, the divided jobs 210 can be associated with groups 230 by more efficient distribution conditions 220, and it can be efficiently distributed and processed. In addition, even in the event of trouble, or the like, it is possible to execute the job 210 by distributed processing.

In the embodiment described above, an example of dividing the jobs 210 without distinguishing between rasterization processing, printing processing, and post-processing has been described.

However, the jobs 210 may be divided by setting separate distribution conditions 220 for rasterization, printing, and post-processing.

This configuration allows for flexible division into groups 230 according to the type and number of component apparatuses in each process.

In the above example, it is described an example in which the group setting 200 is stored at the originating print server and the distribution condition 220 is determined.

However, the group setting 200 and the distribution condition 220 may be set or calculated by a plurality of print servers 1. In this case, the group dividing unit 100 of each print server 1 other than the originating print server may directly group the jobs 210 according to the distribution conditions 220 and request processing to the other print server.

By configuring in this way, jobs 210 can be distributed and processed more efficiently.

In the embodiment described above, an example is described that requesting other print servers to process a job 210 as it is.

However, it is also possible to change the job 210 itself in response to a status notification, completion notification, or error notification of the job 210.

In this case, it is also possible to change job 210 according to processing change information or alternative settings. In other words, when adjusting processing requests due to delays, it is possible to change the number of pages, color profiles used, or the like, as job 210 that can be processed, for example, according to alternative settings.

In the above embodiments, examples of distributed peer-to-peer processing were described.

However, it is also possible to apply each of the processes in the present embodiment in a configuration by using a management server.

In the above embodiments, an example of distributed processing between print servers 1 has been described.

However, it is also possible to perform distributed processing between component apparatuses on a peer-to-peer basis. In this case, for example, a representative print apparatus 2 may be set instead of the representative print server 1 of group 230, and the representative print apparatus 2 may perform the similar processing as a DFE. Furthermore, the component apparatuses may be able to transfer the jobs 210 to each other.

It goes without saying that the configuration and operation of the above-mentioned embodiments are examples and may be modified and implemented as appropriate without departing from the intent of the present disclosure.

In terms used herein, the singular forms “a,” “an,” and “the” also include the plural forms unless the context clearly indicates otherwise.

What is claimed is:

1. An industrial printing system for production printing,
having a plurality of print servers that performs distributed processing of a plurality of jobs, each of the plurality of print servers comprising:
a storage unit that stores a group setting corresponding to a processing capability and a setting of a component apparatus;
a group dividing unit configured to read data content and/or print instruction attributes for each of the plurality of jobs, generates a distribution condition, and divides the plurality of jobs into a group corresponding to the group setting stored in the storage unit according to the distribution condition; and
a processing management unit configured to transmit the jobs of the group divided by the group dividing unit to other print server associated with the group to request to be processed.

2. The industrial printing system according to claim 1, wherein
the group dividing unit calculates processing time when the plurality of jobs is processed according to the distribution condition.

3. The industrial printing system according to claim 1, wherein
the group dividing unit calculates the processing time when the plurality of jobs is equally divided and processed and determines a distribution condition and a group that is allowable to be processed faster than the processing time with equal division.

4. The industrial printing system according to claim 2, wherein
the group dividing unit further selects and divides a group that matches the distribution condition within the group to be divided.

5. The industrial printing system according to claim 1, wherein
the group dividing unit sets a group according to the processing capacity or settings of component apparatus at the distribution destination.

6. A print server that performs distributed processing of a plurality of jobs in an industrial printing system for production printing, comprising:
a storage unit that stores a group setting corresponding to a processing capability and a setting of a component apparatus;
a group dividing unit configured to read data content and/or print instruction attributes for each of the plurality of jobs, generates a distribution condition, and divides the plurality of jobs into a group corresponding to the group setting stored in the storage unit according to the distribution condition; and
a processing management unit configured to transmit the jobs of the group divided by the group dividing unit to other print server associated with the group to request to be processed.

7. The print server according to claim 6, wherein
the group dividing unit calculates processing time when the plurality of jobs is processed according to the distribution condition.

8. The print server according to claim 6, wherein
the group dividing unit calculates the processing time when the plurality of jobs is equally divided and processed and determines a distribution condition and a group that is allowable to be processed faster than the processing time with equal division.

9. The print server according to claim 7, wherein
the group dividing unit further selects and divides a group that matches the distribution condition within the group to be divided.

10. The print server according to claim 6, wherein
the group dividing unit sets a group according to the processing capacity or settings of component apparatus at the distribution destination.

11. A processing management method executed by an industrial printing system for production printing having a plurality of print servers that performs distributed processing of a plurality of jobs, comprising the steps of:
storing a group setting corresponding to a processing capability and a setting of a component apparatus;
generating a distribution condition by reading data content and/or print instruction attributes for each of the plurality of jobs;
dividing the plurality of jobs into a group corresponding to the stored group setting according to the distribution condition; and
transmitting the divided jobs of the group to other print server associated with the group to request to be processed.

12. The processing management method according to claim 11, further comprising a step of:
calculating processing time when the plurality of jobs is processed according to the distribution condition.

13. The processing management method according to claim 11, further comprising a step of:
calculating the processing time when the plurality of jobs is equally divided and processed and determines a distribution condition and a group that is allowable to be processed faster than the processing time with equal division.

14. The processing management method according to claim 11, further comprising a step of:
selecting and dividing a group that matches the distribution condition within the group to be divided.

15. The processing management method according to claim 11, further comprising a step of:
setting a group according to the processing capacity or settings of component apparatus at the distribution destination.
